(19) United States
(12) Patent Application Publication
(10) Pub. No.: US 2015/0227888 A1
(43) Pub. Date: Aug. 13, 2015

(54) METHOD AND SYSTEM FOR MANAGING PREPARATION AND DELIVERY OF GOODS

(71) Applicant: DRAGONTAIL SYSTEMS LTD., Ramat Gan (IL)

(72) Inventors: Ido LEVANON, Tel Aviv (IL); Guy BRANDWINE, Shaarey Tikva (IL)

(21) Appl. No.: 14/621,053

(22) Filed: Feb. 12, 2015

Related U.S. Application Data
(60) Provisional application No. 61/939,340, filed on Feb. 13, 2014.

(51) Int. Cl. G06Q 10/08

(52) U.S. Cl. CPC G06Q 10/0834

(57) ABSTRACT

A method and a system for managing preparation and delivery of goods. The method may include: receiving a plurality of orders via the orders receiving unit, each order may include one or more requested goods and a point of delivery. Each of the requested goods may require at least one preparation stage; calculating estimated traveling time from a preparation facility to at least two points of delivery of at least two of the plurality of orders; estimating at least a traveling time between the at least two points of delivery received for the at least two of the plurality of orders; determining optional sets of orders from the plurality of orders, wherein each of said set of orders comprises at least one order; selecting a first set of orders from the optional sets of orders based at least on the calculated traveling time and the estimated traveling time between the points of delivery; determining arrival time at the preparation facility, of each courier from a plurality of available couriers, the arrival time is determined based on information received from the plurality of mobile devices; selecting a first courier from the plurality of available couriers based on the determined arrival time at the preparation facility; assigning the first set to the first courier, wherein selecting of the first set of orders, selecting the first courier and assigning the first set to the first courier minimize an average time for a delivery of the first set of orders; and determining a timing for the at least one preparation stage of the requested good in the first set of orders according to the selection of the first set and the first courier.

### CROSS REFERENCE TO RELATED APPLICATION

This application claims the benefit of U.S. Provisional Patent Application No. 61/939,340, filed Feb. 13, 2014, which is incorporated by reference in its entirety.

### BACKGROUND OF THE INVENTION

One of the aspects in modern life consumerism is the rapid development of businesses that supply and deliver goods to customers. Such businesses often also prepare, manufacture and/or pack the goods upon receiving an order from the customer. Typical businesses of such nature are: pizza or other fast food providers, flower shops or the like, that both prepare the order and deliver the order to the customer. The main aim of such businesses is to provide the customer with freshly prepared goods as soon as possible. The customer ordering the goods would like to reactive his/her order (e.g., the pizza) as close as possible after the preparation of the goods has been completed. For example, the costumer would like to receive the pizza as soon as possible after the pizza gets out of the oven, the eggrolls as close as possible to being fried, and the flowers as fresh as possible.

Optimizing the preparation time and timing of such orders (e.g., a pizza, Chinese food, a bouquet of flowers, etc.) can be very complicated and usually done according to the chronological order of the received orders (FIFO—first in first out). However, many other parameters and factors affect the delivery time from receiving the order to the delivery of the goods to the customer. Some examples for such parameters are: an availability of a courier (e.g., is there an available courier or how far away is the next courier from the preparation facility or shop), the traffic on the way to and from the shop, the weather, how complicated is the order (e.g., how many ingredients are required in order to prepare the goods included in the order, how many preparation steps) or the like. These parameters also affect the freshness level in which the goods are delivered to the customer. If an order was received and completely prepared before a courier can deliver the order to the customer, the quality of the delivered goods may deteriorate as a function of time. For example, a pizza or noodle soup can cool down, an eggroll can lose its crispiness, and a bouquet of flowers can lose its freshness.

### SUMMARY OF THE INVENTION

Some embodiments of the invention may be related to a method and a system for managing preparation and delivery of goods. The goods may be prepared in a preparation facility, for example, a pizzeria, a Chinese restaurant or any other fast food or food provider. The goods may be delivered to a costumer by a courier. A system according to some embodiments of the invention may include: an order receiving unit; a communication unit in communication with a plurality of mobile devices each associated with a courier and a processor for executing instructions.

The system may further include a preparation timing unit comprising an output device to provide preparation timing indications for each order received in an order receiving unit and a memory stored thereon the instructions to be executed by the processor. In some embodiments, the instructions may comprise the following method operations: receiving a plurality of orders via the orders receiving unit, each order comprising one or more requested goods and a point of delivery, wherein each of the requested goods requires at least one preparation stage; calculating estimated traveling time from a preparation facility to at least two points of delivery of at least two of the plurality of orders; estimating at least a traveling time between the at least two points of delivery received for the at least two of the plurality of orders; determining optional sets of orders from the plurality of orders, wherein each of said set of orders comprises at least one order; selecting a first set of orders from the optional sets of orders based at least on the calculated traveling time and the estimated traveling time between the points of delivery; determining arrival time at the preparation facility, of each courier from a plurality of available couriers, the arrival time is determined based on information received from the plurality of mobile devices; selecting a first courier from the plurality of available couriers based on the determined arrival time at the preparation facility; assigning the first set to the first courier, wherein selecting of the first set of orders, selecting the first courier and assigning the first set to the first courier minimize an average time for a delivery of the first set of orders; and determining a timing for the at least one preparation stage of the requested good in the first set of orders according to the selection of the first set and the first courier.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high level block diagram of an exemplary system for managing preparation and delivery of goods according to some embodiments of the invention;

FIG. 2 is a high level block diagram of an exemplary mobile device according to some embodiments of the invention;

FIG. 3A is a flowchart of a method of managing preparation and delivery of goods in according to some embodiments of the invention;

FIG. 3B is a flowchart of a method of managing preparation and delivery of goods during an unexpected event according to some embodiments of the invention;

FIGS. 4A and 4B are exemplary screenshots of a presentation unit in a preparation facility according to some embodiments of the invention;

FIGS. 5A and 5B are exemplary screenshots presenting to a user of the system according to embodiments of the present invention, a status of the orders and the couriers; and

FIG. 6 is an exemplary screenshot of a display of a mobile device associated with couriers according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Aspects of the invention may be related to a system and method of managing preparation and delivery of goods in a preparation facility. The goods may be delivered by any number of couriers. A goods provider that may use the system and method of the invention may be able to deliver to its customers freshly prepared goods at relatively short delivery time. The goods provider may operate one or more preparation facilities (e.g., a pizzeria and Italian restaurant) and may include in the order goods prepared in the one or more of the preparation facilities. The one or more preparation facilities may be located at a predetermined distance (e.g., nearby) from each other. The delivery time of the order may include the total time from receiving the order from the client to delivering the order to the client. Such a method may include optimization of the timing of preparing the goods not just according to the chronological order of receiving the orders, but also according to other parameters as well, for example, is there an available courier to deliver the order, how far away is the closest courier, are there any other orders that could be delivered to a nearby address, how many goods are included in the order, how are the weather conditions and how is the traffic state to and from the provider's preparation facility or the like.

A system according to embodiments of the invention may include two major subsystems: a stationary system associated with the preparation facility and a mobile device carried by each courier. The stationary system may include an order receiving unit for receiving the orders. The orders may be received from a website of the provider, during a phone conversation with a representative of the provider, using an application on a mobile device or the like. The system may manage the preparation of take-away orders and orders dine within the preparation facility. All the received orders may be collected and stored in the order receiving unit.

The stationary system may further include one or more flow instruction timing units for presenting a time table and instructions for preparing each stage in the preparation of each good. The presentation unit may be placed in a kitchen preparing food, in a flower shop or the like. The presentation unit may include, for example, a screen, a printer for printing the stages, speakers that verbally announce the coming stage in the preparation process, or a combination thereof. The presentation unit may present to one or more workers preparing the goods timings for the different preparation stages for each good. For example, when backing a pizza, the instructions may include: timing for beating flat pizza dough, timing for putting toppings, timing for placing the pizza in the oven and timing for packing the pizza and batching the pizza with the rest of the ordered goods (e.g. a soft drink, an appetizer and the liked). It should be appreciated that the above listed stages are exemplary and some or the stages may not be required or may be combined with other stages.

The system may optimize the timing of each stage such that the baked pizza may come out of the oven and packed as close as possible to the departure of the courier delivering the pizza.

The stationary system may further include a processing unit to control and optimize the preparation duration and timing of preparing the received orders. The processing unit may include a processor and a memory and may communicate and control all the other components of the system, both in the stationary system and in the mobile devices. The mobile device may be for example, a smartphone, a tablet, a lap-top computer, a localization system (e.g., Global Positioning System—GPS) attached to the courier's vehicle or the like. The mobile devices may include a localization system that may indicate to the processor the location of the courier carrying the mobile device.

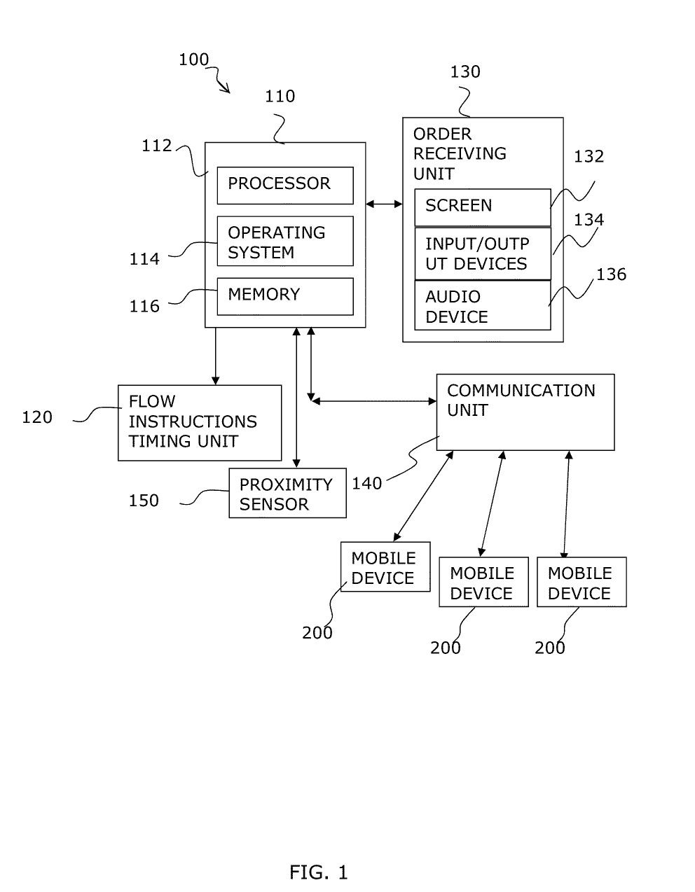

Reference is made to FIG. 1, which is a high level block diagram of an exemplary system 100 for managing preparation of goods in a preparation facility according to some embodiments of the invention. System 100 (e.g., a stationary system) may include a processing unit 110, one or more flow instruction timing units 120, one or more orders receiving unit 130 and communication unit 140 to communicate with two or more mobile devices 200.

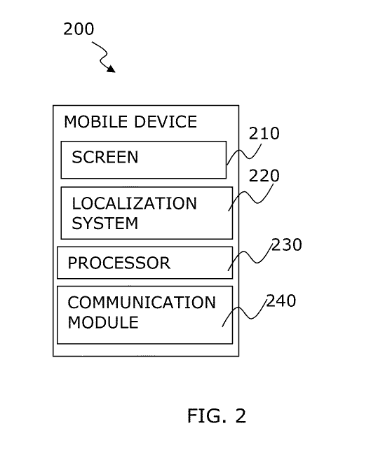

Processing unit 110 may include a processor 112 that may be, for example, a central processing unit (CPU), a chip or any suitable computing or computational device, an operating system 114 and a memory 116. System 100 may be included in a desktop computer, laptop commuter, a tablet, a mainframe computer or the like. Processor 112 or other processors such as processor 230 (in FIG. 2) may be configured to carry out methods according to embodiments of the present invention by for example executing instructions stored in a memory such as memory 116.

Operating system 114 may be or may include any code segment designed and/or configured to perform tasks involving coordination, scheduling, arbitration, supervising, controlling or otherwise managing operation of processing device 110, for example, scheduling execution of programs. Operating system 114 may be a commercial operating system. Memory 116 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 116 may be or may include a plurality of, possibly different memory units.

Memory 116 may store any executable code, e.g., an application, a program, a process, task or script. The executable code may include codes (e.g., operations) for controlling and managing preparation and delivery of goods or any other codes or instruction for executing methods according to embodiments of the present invention. The executable code may be executed by processor 112 possibly under control of operating system 114. In some embodiments, processing unit 110 may include or may be in communication with a storage unit (not illustrated). The storage unit may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in the storage unit and may be loaded from the storage unit into memory 116 where it may be processed by processor 112.

Flow instruction timing unit 120 may include any device, system or element comprising an output device to provide preparation timing indications and instructions for each good included in the order received in order receiving unit 130. In some embodiments, system 100 may include more than one preparation timing units, for example, one unit may be located in a kitchen and one in the office of a shift manager. For example, one or more preparation timing units located in the kitchen may present to the cooks preparation instructions that may include the timing (e.g. when to start each stage of the preparation) for each stage in the preparation process of each order. In some embodiments, the instructions may further include: a list of goods included in the order, a list of orders, ingredients needed in each stage, a preparation unit (e.g., an oven, a fryer, etc.) needed for the stage, or the like.

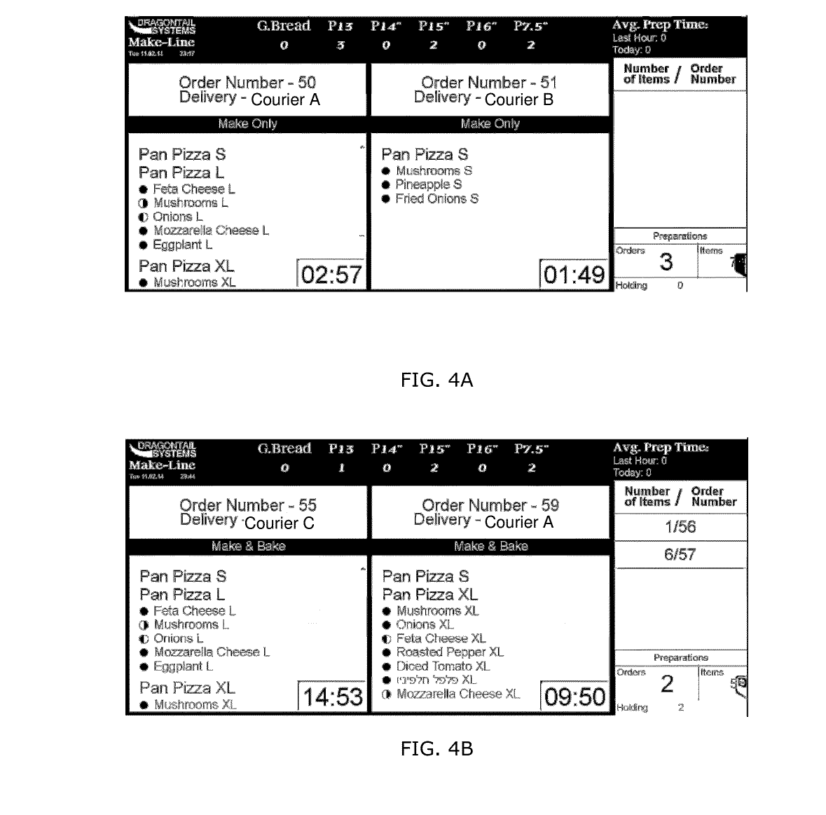

Flow instruction timing unit 120 may include any type of screen or display and/or any audio or video display. For example, one or more common screens may be placed (e.g., on one or more walls) in a kitchen of a Chinese restaurant, for presenting the preparation instructions to the cook(s) preparing the orders, additionally or alternatively each cook may have his own screen (e.g., a tablet) and may be able to send back to processor 112 feedback regarding the preparation progress (e.g. pre-baking preparation completed, the pizza is ready for baking). In yet another example, a computerized audio unit may use speakers to verbally present the preparation instructions to bakers backing pizzas. A set of instructions may be pre-recorded by a user and stored (e.g., in a storage unit) to be used by the computerized audio unit. Exemplary screens included in a presentation unit according to embodiments of the invention are shown in FIGS. 4A and 4B and discussed below.

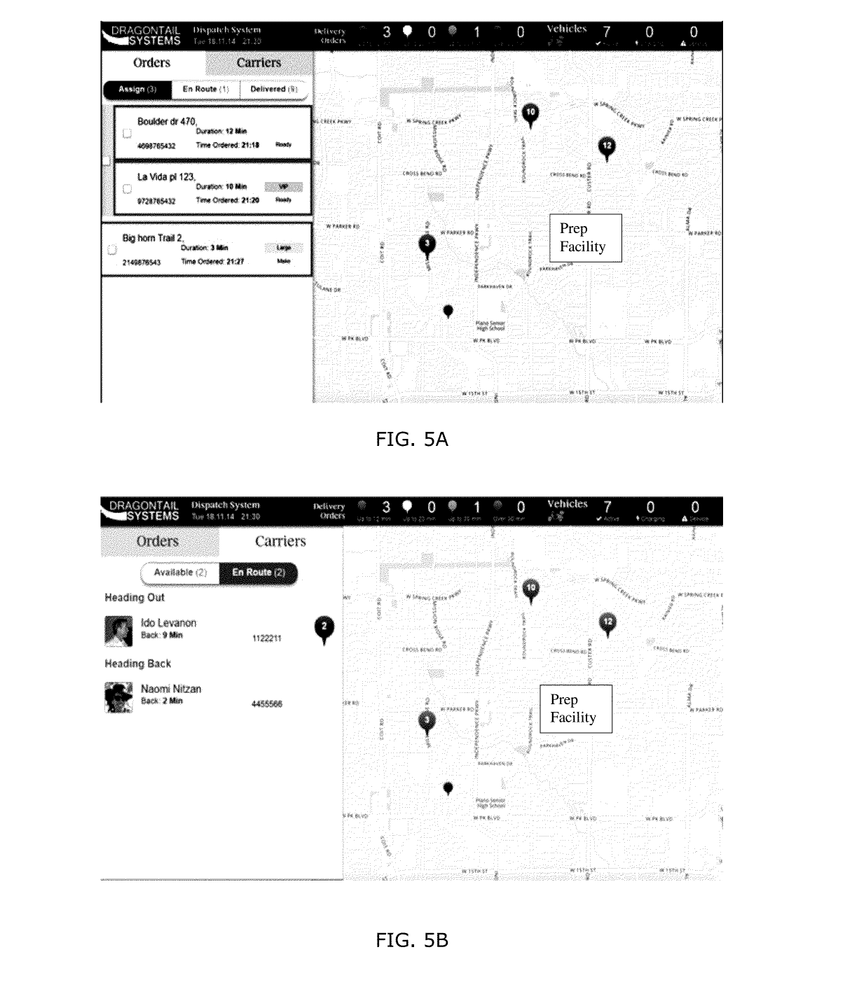

In some embodiments, flow instruction timing unit 120 may further display other timing indications such as timing indication(s) related to the couriers, the assignment of orders into sets of orders and further assignment of each set to a courier or the like. Processor 112 may be configured to display to a user (e.g., shift manager, preparation facility manager, the courier, etc.) on a screen included in unit 120 the status of the orders and couriers. For example, processor 112 may display on a map (e.g., in real time) the location of each courier with respect to the preparation facility and the preferred route. Processor 112 may further display a status of each courier, for example, what is the expected arrival time of the courier, what order(s) the courier is delivering, is the courier on his way from or to the facility, and the like. In some embodiments, processor 112 may be configured to present to the user the status of at least some of the orders. For example, the processor may present the current stage of preparation of each order, when the order is expected to be ready for delivery, which orders were grouped together into a single set, which courier is assign to the set, an expected arrival time of that courier, recommendations related to preparation facility resources (e.g., bring another courier, power another oven etc.) or the like. Exemplary screens that are included in unit 120 are shown in FIGS. 5A and 5B and discussed below.

Order receiving unit 130 may include a screen 132, an input/output device 134 and an audio device 136. An order may be received in order receiving unit from a telephone conversation received by a representative of the goods provider, a website operated by the goods provider or otherwise associated with the goods provider, a fax sent by the costumer, an application running on a smartphone and operated by the goods provider, or the like. Screen 132 may include a monitor, a display, a CRT, or the like. Input/output device 134 may include a keyboard, a mouse, a touch screen or a pad, a wired or wireless network interface card (NIC), a modem, printer or facsimile machine, a universal serial bus (USB) device or external hard drive or the like. Audio device 136 may include: a microphone, a telephone receiver, one or more speakers, earphones and/or any other suitable audio devices.

Communication unit 140 may include any wireless communication for communicating with two or more mobile devices 200 (in FIG. 2). Each of mobile devices 200 may be associated with one courier. Communication unit 140 may include wireless network interface card (NIC), a wireless antenna, a transceiver or any other device that may be required for establishing wireless communication. Communication unit 140 may communicate using satellite communication, Wi-Fi communication, Bluetooth communication, cell-phone communication or the like.

According to some embodiments of the present invention, system 100 may further comprise one or more proximity sensors 150 such as an RFID unit or Bluetooth, or any other receiver located in the preparation facility for identifying when a courier is in the preparation facility and proximate to the proximity sensors. It should be appreciated that the couriers may carry a chip, a transmitter or any other element adapted to communicate with proximity sensor(s) 150, so that system 100 may identify which courier is in the preparation facility even when no signals are received from a localization system (220 in FIG. 2) such as GPS, and/or no cellular connection is available. For example, an RFID unit may be included in a courier's identification badge (e.g., a card), such that when the courier enters the Chinese restaurant, he places the identification badge in proximity to an RFID sensor and system 100 is notified that this particular courier just entered the restaurant.

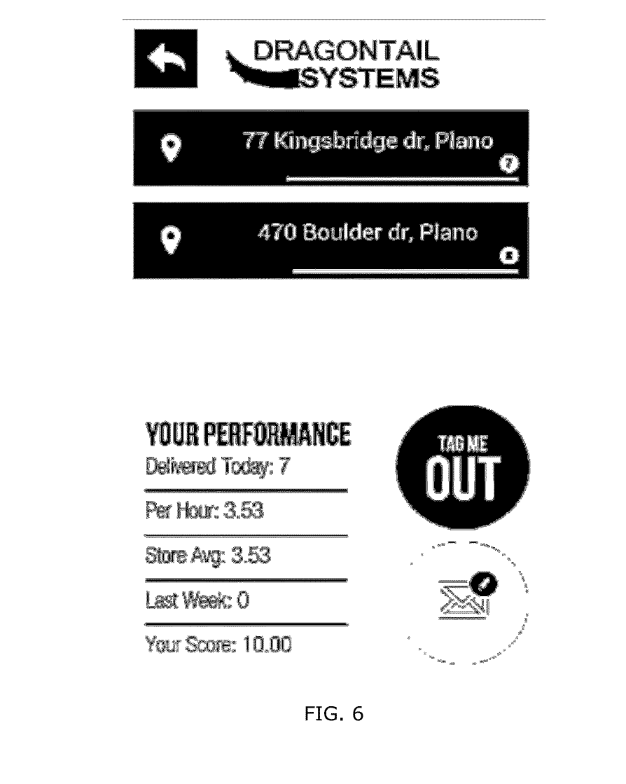

Reference is made to FIG. 2 that is a high level block diagram of an exemplary mobile device according to some embodiments of the invention. A mobile device 200 may include a screen 210, a localization system 220 and a processor 230. Mobile device 200 may be a smartphone, a tablet, a laptop computer or the like. Screen 210 may be any display for displaying instructions to the courier. The instructions may comprise a list of orders to be delivered, the destination of each order, the route (e.g., a map) to each destination and the like. An exemplary screen 220 is shown in FIG. 6 and discussed below.

Localization system 220 may be configured to determine the location of the courier in real time, for example, using Global Positioning System (GPS). Processor 230 may include a chip or any suitable computing or computational mobile device. Mobile device 200 may further include a communication module 240 for communicating with system 100. Processor 230 may be configured to send system 100 the location of the courier received from localization system 220, either continuously or every predefined time interval, such as every 15 seconds, every 30 seconds or the like. According to some embodiments, the time intervals may change as a function of the courier's velocity, such as, for example, every 1 minute when the courier is traveling in less than 10 Miles per Hour (mph), every 30 seconds when the courier is traveling in a speed ranging from 11 mph to 30 mph, every 15 seconds when the courier is traveling in a higher velocity and every 2 minute when the courier is immobile. It should be appreciated that other or additional ranges may be defined.

Processor 230 may further be configured to display on screen 210 instructions received from system 100.

In some embodiments, mobile device 200 may include only localization system 220 comprising a transmitter. Localization system 220 may be configured to transmit to communication unit 140 and/or proximity sensor 150 of system 100, information related to the location of the courier carrying device 200.

Embodiments of the invention may include an article such as a computer or processor non-transitory readable medium or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage unit.

A system according to some embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

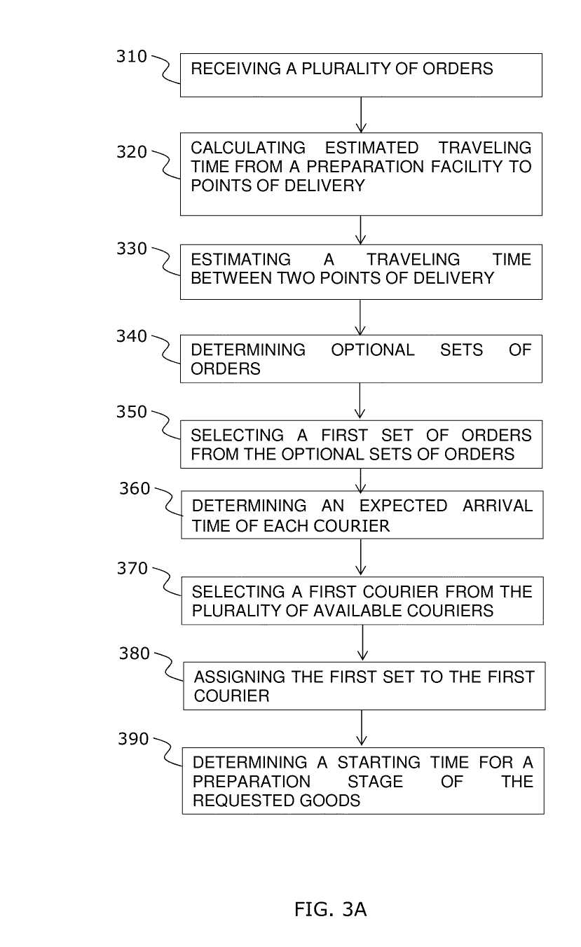

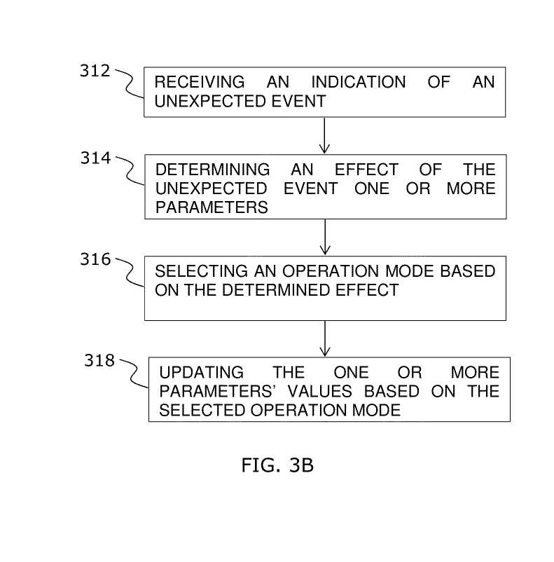

Reference is made to FIG. 3A that includes a flowchart of a method of managing preparation and delivery of goods. The method of FIG. 3 may be executed by a processor (e.g., processor 112 of processing unit 110) according to instructions stored in a memory (e.g., memory 116) or by any other suitable system. In box 310, the method may include, according to some embodiments, receiving a plurality of orders, each order comprising one or more requested goods and a point of delivery (e.g. a destination to which the order should be delivered), wherein each of the requested goods requires at least one preparation stage. As used herein, the term “goods” presents any item that is ordered by a customer and can be supplied by the goods provider, for example, goods may include: food items (including beverages), flowers, or the like. The orders may be received from an order receiving unit (e.g., unit 130), for example, via a website of the provider, an application running on a mobile device and/or via a telephone conversation with a representative of the provider.

A point of delivery according to some embodiments of the invention may include: an address to which the order should be delivered, a geographical location that does not have a specific address (e.g., a bench on the north corner of a park) or geographical coordinates (e.g., received from a GPS system).

The order may include one or more goods, for example, an order from a pizzeria may include one pizza, or two pizzas and a bottle of soft drink, a pizza and garlic bread or just one bottle of soft drink. In yet another example, an order from a Chinese restaurant may include two wanton soups, three eggrolls and a soft drink, fried rise and noodles, or the like. In some embodiments, the plurality of orders may include all the orders still in the preparation facility (e.g., the orders that had not yet left the facility with a courier). Such orders may include prepared orders (e.g., pizzas baked and packed, packed soft drinks, etc.), orders during the preparation process (e.g., eggrolls ready for frying, pizza ready for baking, goods ready for packing, etc.) and received orders not yet in preparation process.

Each good included in the order may require at least one preparation stage to be ready to be delivered to the customer. The preparation stages may include at least packing the goods. In some embodiments, the preparation stages may include, manual stages (e.g., kneading flat a pizza dough, chopping vegetables, mixing sauces, etc.), mechanized (e.g., automatic or semi-automatic) stages (e.g., baking the pizza in the oven, frying eggrolls in a fryer or the like), a packing stage (packing the fried rise in a box, inserting a bottle of soft drink into a paper bag, etc.) and a batching stage (e.g., grouping together all goods within one set of orders to be ready to be picked up by the same courier).

In some embodiments, the method may include receiving a single order, the order may include one or more goods. Upon receiving a single order, for example, at the beginning of a shift, at the opening hour of the pizzeria, or the like, the order may be prepared and delivered, even if no additional orders were received. If a second order is received during the preparation stage of the first order the method may include applying operations 320-390 to optimize the preparation and delivery process of the first and second orders.

In box 320, the method may include calculating estimated traveling time from a preparation facility to at least two points of delivery of at least two orders of the plurality of orders. The preparation facility may include a place having the required equipment and manpower for preparing the plurality of orders. For example, the preparation facility may be a Chinese restaurant, an Italian restaurant, a pizza bakery, a burgers shop, a flowers shop or a combination of two or more preparation facilities. Calculating estimated traveling time from the preparation facility to a point of delivery may include calculating the estimated time that takes a courier to travel from the preparation facility to the point of delivery. The estimated time may be calculated, based on several known parameters. For example, such parameters may comprise, the distance (traveling distance) between the preparation facility to the point of delivery, the vehicle used by the courier (e.g., a motorbike, bicycle, car, etc.), an expected traffic at a given hour, the weather, an average traveling time from the preparation facility to the delivery points or nearby points collected and stored in the system from previous travels, or the like. In some embodiments, some of the known parameters may be received from a database associated with the processor (e.g., processor 112), for example, the traveling distance, the average traveling time, or the like. Some known parameters may be received in real time from outer sources, for example, via the internet. For Example, traffic information, weather conditions or the like may be received from, a traffic control center and meteorological service center.

According to some embodiments, processor 112 may calculate estimated traveling time from the preparation facility to at least two points of delivery of the plurality of orders. The processor 112 may calculate the time to a number of delivery points from the plurality of delivery points, for example, delivery points included in a single area of delivery (e.g., delivery points within a predetermined distance from each other, all delivery points included in a single zone in a city, all delivery points included in a particular village or the like).

In box 330, the method may include estimating at least a traveling time between the at least two points of delivery. Processor 112 may estimate a time that will take a courier to travel from one point of delivery to another. The processor may estimate the time based on, the traveling distance, the vehicle used by the courier (e.g., a motorbike, bicycle, car, etc.), an expected traffic at a given hour, the weather, or the like. The processor may estimate the time between each two points of the delivery for only a number of the plurality of orders. For example, the processor may estimate the time between two points of delivery included in a single area of delivery (e.g., all delivery points within a predetermined distance from each other, all delivery points included in a single zone in a city, all delivery points included in a particular village or the like).

In box 340, the method may include determining optional sets of orders from the plurality of orders, wherein each of said optional sets of orders comprises at least one order. Processor 112, may group together two or more sets of orders, or may include only one order in a set. The processor may select to include an order in more than one optional set. For example, a first order: may be included in a first optional set that includes only the first order, may be included in a second optional set that includes the first order and a second order or may be included in a third optional set that includes the first and second orders and a third order. Processor 112 may determine optional sets of orders using only a number of orders from the plurality of orders, for example, using orders having nearby delivery points.

In box 350, the method may include selecting a first set of orders from the optional sets of orders based at least on the calculated traveling time and the estimated traveling time between the points of delivery. Processor 112 may select a first set of orders such that the traveling time from the preparation facility to at least one delivery point is minimal, or total set traveling time is minimal. According to other embodiments, processor 112, may select the first set such that the total traveling time from the facility to the first point of delivery and the traveling time from the first point to the second point of delivery is minimal, or the like.

In some embodiments, the method may include determining a priority level of each order. For example, the priority level may be determined based on the chronological order in which the orders have been received (e.g., early orders or orders that have to be delivered at a short time may receive higher priority). In yet another example, orders received from preferred customers (e.g., VIP customers, first time customers, etc.), or orders previous not delivered in time to a same customer may receive higher priority. In some embodiments, processor 112 may determine the optional sets of orders based on the priority level of each order in the set, and/or may further select the first set of orders from the optional sets of orders based on the priority level.

In some embodiments, the method may include determining preparation related parameters. Preparation related parameters may include: preparation duration of each preparation stage of the good (e.g., 5 minutes to make a pizza), a number of stages in a preparation of a good (e.g., one stage if only packing is required, three stages for preparing a pizza (preparing the pizza for baking, baking and packing) or the like), the type of preparation stage, wherein the type of preparation stage includes at least one of: a manual preparation stage, an automatic preparation stage and a packaging stage, or the like.

In some embodiments, processor 112 may be configured to select the first set of orders from the optional sets of orders based on the preparation related parameters. For example, the processor may select to group together orders that may have the same preparation duration.

In some embodiments, the method may include determining delivery related parameters. The delivery related parameters may include, for example, maximal allowed traveling time to the point of delivery, maximal allowed traveling time between two points of delivery, maximal allowed traveling time between all the delivery points in the set of orders, a predefined maximal time for delivery of the order and a weather condition. In some embodiments, processor 112 may select the first set of orders from the optional sets of orders based on the delivery related parameters. For example, processor 112 may select a first set that has a traveling time to the point of delivery of less than 10 minutes and has traveling time between two points of delivery of less than 5 minutes. In some embodiments, the processor may determine or receive different maximal allowed traveling time between two points of delivery, for example, between a first and second orders in a set and the second and third order in the set. For example, the processor may combine together two orders having, for example, maximum of 7 minute of traveling time, but may add to the set a third order only if the order is located less than 3 minutes of traveling time from the second order.

In some embodiments, the method may include selecting a second set of orders from the optional sets of orders based at least on the calculated traveling time and the estimated traveling time between the points of delivery. Selecting the second set may be according to the same principles and may be based on the same parameters as selecting the first set. For example, selecting the second set may be based on at least one of: a priority level, preparation related parameters and traveling related parameters.

In some embodiments, the method may include selecting N sets of orders from the optional sets of orders based at least on the calculated traveling time and the estimated traveling time between the points of delivery. Selecting the N sets of orders may be according to the same principles and may be based on the same parameters as selecting the first and second sets of orders. For example, selecting the N sets may be based on at least one of: a priority level, preparation related parameters and traveling related parameters.

In some embodiments, the method may include determining for each optional set of orders that includes two or more orders a delivery delay parameter. The delivery delay parameter may include a time (or a parameter indicative of the time) in which a delivery of a first order in the set is going to be delayed due to the addition of a second order in the optional set in comparison to a delivery of a set including the first order alone. For example, a delivery delay parameter may include the extra time that the first order needs to wait after packing for the second order to be fully prepared (e.g., baked and packed) for delivery. In some embodiments, selecting the first set of orders may be based on the delivery delay parameter. For example, selecting the first set may include selecting a set with a delivery delay parameter lower than a predetermined threshold value. In some embodiments, selecting the second set or any one of the sets in the N sets of orders may be based on the delivery delay parameter of each optional set.

In box 360, the method may include determining an expected arrival time at the preparation facility, of each courier from a plurality of available couriers. The system (e.g., system 100) may receive localization information related to each courier, for example, via communication unit 140. The localization information may indicate the time distance of the courier from the facility, is the courier on his way from or to the facility, or the like. The localization information may be received from a transmitter associated with the courier, for example, a positioning system (e.g., GPS) located on a courier's vehicle, a positioning system included in a courier's mobile device (e.g., GPS antenna included in a mobile phone), proximity transmitters (e.g., RFID) associated with the courier, or the like. The localization information may be received at receivers located in the preparation facility for example, communication unit 140 and/or proximity sensor 150.

In some embodiments, the expected arrival time may be determined based on time indicators. In some embodiments, a time indicator may include at least one of: the courier is at the facility; the expected arrival of the courier at the preparation facility is less than a first predetermined duration of time; the expected arrival of the courier at the preparation facility is less than a second predetermined duration of time, the second predetermined duration of time is larger than the first predetermined duration of time; and the expected arrival time of the courier at the preparation facility is greater than the second predetermined duration of time. For example, the first predetermined duration of time may be 5 minutes, which is the time required for baking a pizza in an oven, packing it for delivery and batching with the rest of the order (e.g., a soft drink). In yet another example, the second predetermined duration of time may be 8 minutes, which includes the time required for manually preparing the pizza, baking a pizza in the oven, packing it for delivery and batching.

In some embodiments, a time indicator may also include that the expected arrival of the courier at the preparation facility may be less than a calculated preparation time of at least one stage in the preparation of at least one good included in a set of orders. For example, a time indicator may include that a currier is less than the calculated preparation time of three noodle soups and two fried rice dishes included in a set of orders, for example, less than 10 minutes. In yet another example, when two pizza ovens are available and the set of orders includes four pizzas, in order for the courier to be able to arrive in time to deliver the set of orders, the couriers must be less than the calculated backing time of two pizzas one after another (two pizzas are baked in parallel) and the time indicator is, for example, 5+5=10 minutes. If only one pizza oven is available than the time indicator becomes 20 minutes (4×5 minutes).

In some embodiments, the method may include determining a courier as an available courier if the courier is at the facility or the expected arrival time of the courier to the facility is less than the second predetermined duration of time. Available couriers may include all the couriers that are expected to arrive back to the facility in less than the second predetermined duration of time, for example, couriers on their way back to the facility from a delivery task, couriers about to start their shift, or the like. In some embodiments, couriers on their way back to the facility from a delivery task at the end of their shift may not be considered as available couriers.

In box 370, the method includes selecting a first courier from the plurality of available couriers based on the determined expected arrival time at the preparation facility. For example, processor 112 may be configured to select the courier having the shortest arrival time, for example, 0 arrival time since the courier is already in the facility, or a courier 1-2 minutes away from the facility. In some embodiments, the method may include selecting a second courier from the plurality of available couriers based on the determined arrival time at the preparation facility. For example, the first courier may be a courier at the facility and the second courier may be a courier 7 minutes away from the facility (on his way back or on his way to deliver an order but with an estimated time back at the facility, including the delivery time of less than 7 minutes for example). In some embodiments, the method may include selecting N couriers from the plurality of available couriers based on the determined arrival time at the preparation facility. In some embodiments, processor 112 may be configured to select the N couriers having the shortest arrival time to the facility or all available couriers. In some embodiments, N is a number grater or equal to one and smaller or equal to the number of available couriers.

In box 380, the method may include assigning the first set of orders to the first courier. Processor 112 may be configured to assign the first set to the first courier and/or assign the second set to the second courier. In some embodiments, processor 112 may be configured to assign each one of the N sets of orders to one of the N couriers.

In some embodiments, selecting of the first set of orders, selecting the first courier and assigning the first set to the first courier minimize an average delivery time of the first set of orders. The average delivery time refers to an average of all the delivery times of the orders included in the first set of orders. Processor 112 may be configured to select and assign the first set to the first courier such that the delivery time of the orders in the first set is minimal, meaning that the client(s) ordering the orders included in the first set may receive their orders at a minimal time. The time for a delivery of a set of orders may include at least one of: the time left for preparing all the goods included the set of orders (including the time needed for packing the goods), the time until the arrival of the courier after packing (if not in the facility), the time to upload the orders into the courier's vehicle, the time for traveling from the facility to the first delivery point, the time for delivering the good (e.g., time from parking to door and back) and if additional orders included in the set also the time for traveling to the second delivery point and a second delivery time.

In some embodiments, selecting the first set of orders and the second set of orders, selecting the first courier and the second courier and assigning the first set to the first courier and the second set to the second courier minimize the average delivery time of the first set of orders and the second set of orders. The average delivery time refers to an average of all the delivery times of all the orders included in the first and second sets of orders. Processor 112 may be configured to select and assign the first and second sets to the first and second couriers such that the total time needed to prepare, load and deliver the first and second orders is minimized.

In some embodiments, similar method may be applied for optimizing the average delivery time of N sets of orders. In some embodiments selecting the N set of orders, selecting the N couriers and assigning the N sets to the N couriers minimize the total delivery time of all the orders included in the N sets of orders divided by the number of orders included in the N sets of orders.

It should be appreciated by those skilled in the art that minimizing the average delivery time may be replaced by other rule such as minimizing total delivery time, minimum traveling distance, minimizing energy cost, avoiding problematic routes and/or the like.

In box 390, the method may include determining a timing for the at least one preparation stage of the one or more requested goods in the first set of orders according to the selection of the first set and the first courier expected arrival time. In some embodiments, the determining of the timing may be according to time indicators related to each courier. For example, if the first courier is expected to arrive in less than 5 minutes (the first predetermined duration of time), pizzas included in the first order may be put in the oven for baking to be ready to be pickup upon the arrival of the first courier. Such a system may ensure that the pizzas will arrive to the client as hot and fresh as possible. In yet another example, if the second courier is expected to arrive in less than 10 minutes (but more than 5 minutes), pizzas included in the second set of orders may be manually prepared (flattening the dough, adding tomato source, cheese and toppings) and later put in the oven when the courier is 5-6 minutes away from the facility. In some embodiments, the method may include determine the timing of the preparation stages for the goods included in the first set of orders based on the time indicators of the first courier.

In some embodiments, the method may further include receiving a preparation facility parameter. The facility parameters may include parameters related to the resources and conditions related to the facility. The preparation facility parameters may include at least one of: a number of workers available for preparing the first set of orders (e.g., number of cooks), a number of available couriers and a number of preparation units available for preparing the first set of orders (e.g., number of pizza ovens, fryers, stoves, soda fountain machines, or the like that are available (e.g. in order but idle)). Processor 112 may select the first set of orders; select the first courier and assign the first set to the first courier based on the preparation facility parameter. The processor may further use the preparation facility parameters to select the second set of orders; select the second courier and assign the second set to the second courier; and select and assign the N sets of orders to the N couriers.

Reference is now made to FIG. 3B that is a flowchart of a method of managing preparation and delivery of goods during an unexpected event according to some embodiments of the invention. An unexpected event according to some embodiments of the invention may be an event that could not be expected or predicated and may have an impact or affect at least one of: the preparation of at least one order from the plurality of orders and the delivery of at least one order from the plurality of orders. Such an unexpected event may change the resources of the preparation facility (e.g., increase or decrease the number of couriers, workers or preparation units), change the working conditions (e.g., a weather change) or change in the orders (e.g., cancelation of orders). In box 312, the method may include receiving an indication of an unexpected event. The indication may be received after the operation in box 310 of the method of FIG. 3 or after any other operation 320-390.

In box 314, the method may include determining an impact or effect of the unexpected event on one or more parameters: The one or more parameters may include: the estimated traveling time from the preparation facility to at the least two points of delivery; the traveling time between the at least two points of delivery; the preparation parameter; the delivery parameter and the facility parameter, disclosed and discussed above. A determined effect may change the value of the parameter. For example, the unexpected event may be an accident involving one of the couriers and the determined effect may be reducing the number of available couriers. In yet another example, the unexpected event may be an electric short circuit in one of the pizza ovens and the determined effect may be reducing the number of pizza ovens.

In box 316, the method may include selecting an operation mode based on the determined effect. The operation mode may include changing the maximal delivery time, the maximal traveling time between two points of delivery or the like. If the unexpected event may cause a delay in the delivery, the system may operate under an optional delay mode. In some embodiments, the system may send customers alerts that the delivery of the order may be delayed.

In box 318, the method may include updating the one or more parameters' values based on the selected operation mode and determined effect. For example, the number of available couriers may be updated (e.g., reduced if a courier is delayed or increase if a courier was added). In yet another example, the estimated traveling time to a delivery point may change due to a change in the weather (e.g., a beginning of a rain storm).

In some embodiments, the updated one or more parameters' values may affect the selecting and assigning of the first set to the first courier based, as disclosed with respect to the operations in boxes 350, 370 and 380. In some embodiments, the method may include selecting and assigning the first set to the first courier based on the updated one or more parameters' values to minimize an average delivery time of the first set of orders.

In some embodiments, the method may include receiving an alert when a delay is expected in the arrival time of the courier to the preparation facility. If a delay is expected in the arrival time of the first, second or N courier, in comparison to the estimated traveling time, due for example, to unexpected traffic jam (e.g., due to a car accident) processor 112 may receive an alert. The alert may be sent manually by the courier (e.g., via mobile device 200) or automatically using a localization system (e.g., system 220)—or external system when the courier is not on the move for a predetermined period of time. In some embodiments, the method may change the selection of the first courier, the second or any one of the N couriers based on the received delay. In some embodiments, the method may change the selection of the first set, the second or any one of the N sets based on the received delay.

In some embodiments, the operations in boxes 310-390 or any other operations disclosed above may be periodically repeated and updated. For example, at least some of the operations 310-390 or any other operations disclosed above may be repeated and updated every time a new order is received, or every time a predetermined number of orders is received. In yet another example, at least some of the operations 310-390 or any other operations disclosed above may be repeated and updated every time an available courier is added to (or subtract from) a list of available couriers, for example, when a new courier starts his shift, an estimated arrival time of a courier drops under the second predetermined duration of time, or the like. In some embodiments, at least one of the operations may be timely updated, updated following an input received from a worker, an input received from a courier and/or an input automatically received from a preparation unit.

In some embodiments, the method may include presenting the determined timing, using for example, presentation unit (also referred to as flow instruction timing unit) 120. At least some of the stages timing included in the preparation process of a good may be presented using one or more presentation units 120. Presentation unit 120 may be placed in a kitchen, near a baking oven, near the packing and batching station or the like. In some embodiments, presentation unit 120 may include one or more input devices and may be configured to receive inputs from the worker preparing the goods. For example, presentation unit 120 may include a touch screen so that a cook or a baker may indicate to processor 112 that a stage in the preparation has started and/or finished via the touch screen.

Exemplary screen (included in flow instruction timing unit 120) for presenting preparation stages timing in a pizzeria, according to some embodiments of the invention, are shown in FIGS. 4A and 4B. FIGS. 4A and 4B are exemplary screens presenting to pizza bakers in a pizzeria. The upper portion of each screen includes the number of baking goods needed in the coming orders (e.g., garlic bread, 13″ pizza, 14″ pizza, etc.). The middle portion includes two windows dedicated to two different orders, optionally assigned to a specific courier, for example, in FIG. 4A order no. 50 is assigned to courier A and order number 51 to courier B and in FIG. 4B order 55 is assigned to courier C and order number 59 to courier A. The lower windows of the screens present for each order the types of pizzas to prepare, the starting time for preparing the pizzas and if the preparation include, making the pizzas (e.g., without baking) as presented in FIG. 4A, or making the pizzas and baking as presented in FIG. 4B. If the pizzas were already made, the screen may present starting time (or timing) for baking the pizzas only. The screens in FIGS. 4A and 4B are given as an example only and it should be noted by those skilled in the art that the invention is not limited to this particular form of screens.

Reference is made to FIGS. 5A and 5B, which show exemplary screens presenting to user a status of the orders and the couriers according to some embodiments of the invention, for example, screens include in a preparation timing unit. The screen of FIG. 5A shows on the right side a map indicating the location of each courier and the delivery points of at least some of the orders (e.g., the orders being delivered in the next 10 minutes by couriers already on their way). The left side of the screen discloses the status of at least some of the orders, for example, the preparation/delivery duration, which orders are grouped into one set (e.g., the two upper orders), which courier is assigned to these orders or the like. The screen of FIG. 5B shows on the right side the same map as the screen of FIG. 5A and on the left side, the status of the couriers, for example, what is the expected arrival time for each courier (e.g., 2 minutes for Naomi, and 9 minutes for Ido), is the courier on his/her way back to the facility (e.g., Naomi) or from the facility (e.g., Ido), which courier is delivering a set of orders (e.g., Ido) or the like. The screens in FIGS. 5A and 5B are given as an example only and it should be noted by those skilled in the art, that the invention is not limited to this particular form of screens.

Reference is made to FIG. 6, which is an exemplary screen (e.g., screen 220) included in a mobile device associated with a courier. The screen may present to courier information required to successfully complete the delivery task. For example, as illustrated in FIG. 6, the information may include: the number of orders, the address of each order, which order is to be delivered first (e.g., order 7) or the like. The screen may further present statistical information related to the performance of the courier. For example, in the lower portion of the screen the courier may find: how many orders he/she delivered today, how many per hour, what is the average deliveries per hour of all the couriers in the shift, and his personal rate. The screen in FIG. 6 is given as an example only, and it should be noted by those skilled in the art that the invention is not limited to this particular form of screen.

Some aspects of the invention may be related to a simulation of a preparation and delivery processes for a preparation facility. Processor 112 may be configured to receive historical information related to preparation and delivery of goods for a particular preparation facility. For example, the processor may receive data gathered during a working day in a pizzeria. An exemplary data may include, the order's chronological number, an address (the delivery point), the time of the receiving the order, the number of goods included in the order, an identification no. of the courier delivering the order and the preparation time and traveling time of each order.

The received data may be analyzed by processor 112 according to the following method. The method may include at least some of the operations in boxes 310-390. The method may analyze the data at one point in time, for example, after 1 hour from opening hour, or at the end of the working day, and may use data received at that point in time. The method may include calculating estimated traveling time from the preparation facility to each point of delivery (e.g., an address) and estimating a traveling time between some pairs of points of delivery. The method may further include determining optional sets of orders and selecting sets of orders from the optional sets of orders based on the calculated traveling time and on the estimated traveling time between a pair of delivery points. The method may further include determining an expected arrival time at the preparation facility, for each courier, determining a group of available couriers and assigning each of the couriers to one of the selected sets.

The selection and assigning of the sets and the couriers may be such that the average delivery time of all orders in the selected sets is minimized. The method may further include repeating the above operations (or steps) at various points in time during the working day (or a shift), for receiving an optimal preparation and delivery scheme for the entire working day. In some embodiments, the method may include presenting the optimized preparation and delivery scheme for a client. Table 2 is an exemplary optimized preparation and delivery scheme presenting a portion of the orders received between 12:00-12:10 AM. The scheme presents to the client an optimized selection of orders to be included in each set and an optimized assignment of each set to a courier. An exemplary scheme is presented in table 1.

TABLE 1

| | | | | | preparation | Traveling | |
|---|---|---|---|---|---|---|---|
| | | Order | No. of | courier | time | time | Set |
| order no. | address | Time | goods | No | [min] | [min] | No |
| 1 | 42 A street, Emerald City | 12:00 | 1 | 2 | 13.80 | 1 | 1 |
| 2 | 13 B street, Emerald City | 12:01 | 3 | 4 | 16.80 | 6 | 2 |
| 3 | 48 A street, Emerald City | 12:03 | 2 | 2 | 18.80 | 7 | 1 |
| 4 | 15 C street, Emerald City | 12:05 | 4 | 4 | 14.80 | 1 | 2 |
| 5 | 33 C street, Emerald City | 12:06 | 4 | 4 | 16.60 | 5 | 2 |
| 6 | 11 Q street, Emerald City | 12:08 | 4 | 5 | 17.90 | 7 | 3 |
| 7 | 22 D street, Emerald City | 12:10 | 3 | 6 | 14.00 | 4 | 4 |
| 8 | 4332U, Emerald City | 12:11 | 2 | 6 | 18.90 | 6 | 4 |
| 9 | 55 E street, Emerald City | 12:12 | 3 | 1 | 16.30 | 1 | 5 |
| 10 | 66 D street, Emerald City | 12:12 | 7 | 6 | 16.20 | 3 | 4 |
| 11 | 77 A street, Emerald City | 12:13 | 2 | 2 | 19.70 | 1 | 6 |
| 12 | 88 R street, Emerald City | 12:14 | 3 | 4 | 21.7 | 7 | 7 |
| 13 | 4992U, Emerald City | 12:15 | 1 | 4 | 17.9 | 8 | 7 |
| 14 | 101 A street, Emerald City | 12:16 | 4 | 3 | 17.9 | 2 | 8 |
| 15 | 12 T street, Emerald City | 12:18 | 1 | 4 | 16.2 | 4 | 7 |
| 16 | 23 T street, Emerald City | 12:18 | 8 | 4 | 20.1 | 4 | 7 |
| 17 | 34 T street, Emerald City | 12:18 | 4 | 4 | 18.8 | 6 | 7 |
| 18 | City Hall, Emerald City | 12:20 | 4 | 3 | 18.8 | 5 | 8 |

As one can see the total preparation and traveling time of each order is below 30 minutes, ensuring a timely delivering of fresh hot goods to the customer. Sets 1-8 assigned to various couriers include 1-5 orders. For example, set 3 includes only order no. 6, and set 7 includes orders no, 12, 13, 14, 15 and 17. Simulations done for actual pizzerias using methods and system of the invention yields in potential saving of more than 20% in the delivery time while ensuring that almost all orders are delivered in less than 30 minutes.

In some embodiments, the simulation may assist managing the resources of the preparation facility, for example, optimizing the number of ovens, the number of cooks and the number of couriers. For example, the simulation disclosed above may be conducted with a different number of couriers than the one currently employed in each sift, for example, a higher number of couriers or a lower number of couriers. The simulation may yield that adding X couriers may shorten the delivery time and reducing X couriers may increase the delivery time but lower the labor cost. The simulation may be conducted for various values of X (e.g., 1-10). The result may indicate if it will be benefiting to increase the number of couriers and what is the optimal number, or what will be the consequences of reducing the number of couriers and if it will dramatically reduce the delivery time. The same methodology can be used with any variable parameter of the preparation facility, for example, the number of worker, the number of production units (e.g., ovens) or the like.

While certain features of the invention have been and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of managing preparation and delivery of goods, comprising:
receiving a plurality of orders, each order comprising one or more requested goods and a point of delivery, wherein each of the requested goods requires at least one preparation stage;
calculating estimated traveling time from a preparation facility to at least two points of delivery of at least two of the plurality of orders;
estimating at least a traveling time between the at least two points of delivery;
determining optional sets of orders from the plurality of orders, wherein each of said optional sets of orders comprises at least one order;
selecting a first set of orders from the optional sets of orders based at least on the calculated traveling time from the preparation facility to each of the at least two points of delivery and the estimated traveling time between the at least two points of delivery;
determining an expected arrival time at the preparation facility, of each courier from a plurality of available couriers;
selecting a first courier from the plurality of available couriers based on the determined expected arrival time at the preparation facility;
assigning the first set to the first courier,
wherein selecting of the first set of orders, selecting the first courier and assigning the first set to the first courier minimize an average delivery time of the first set of orders; and
determining a timing for the at least one preparation stage of the one or more requested goods in the first set of orders according to the selection of the first set and the first courier expected arrival time.

2. The method of claim 1, further comprising:
selecting a second set of orders from the optional sets of orders based at least on the calculated traveling time and the estimated traveling time between the points of delivery;
selecting a second courier from the plurality of available couriers based on the determined arrival time at the preparation facility; and
assigning the second set to the second courier,
wherein selecting the first set of orders and the second set of orders, selecting the first courier and the second courier and assigning the first set to the first courier and the second set to the second courier minimize the total time for delivery of the first set of orders and the second set of orders.

3. The method of claim 2, comprising:
selecting N sets of orders from the optional sets of orders based at least on the calculated traveling time and the estimated traveling time between the points of delivery;
selecting N couriers from the plurality of available couriers based on the determined arrival time at the preparation facility; and
assigning each one of the N sets of orders to one of the N couriers,
wherein N is a number grater or equal to one and smaller or equal to the number of available couriers, and
wherein selecting the N set of orders, selecting the N couriers and assigning the N sets to the N couriers minimize the total preparation and delivery time of all the goods included in the N sets of orders divided by the number of orders included in the N sets of orders

4. The method of claim 1, wherein the plurality of orders includes all the orders still in the preparation facility.

5. The method of claim 4, wherein all the orders still in the preparation facility includes: prepared orders, orders during the preparation process and as received orders.

6. The method of claim 1, further comprising:
determining a priority level of each order,
wherein determining the optional sets of orders is based on the priority level of each order.

7. The method of claim 1, further comprising:
determining preparation related parameters, and
wherein selecting the first set of orders from the optional sets of orders is based on the preparation related parameters.

8. The method of claim 7, wherein the preparation related parameters include at least one of:
preparation duration of each preparation stage of the goods;
number of stages in a preparation of the goods; and
the type of preparation stage, wherein the type of preparation stage includes at least one of: a manual preparation stage, an automatic preparation stage and a packaging and batching stage.

9. The method of claim 1, further comprising:
determining a delivery related parameters, and
wherein selecting the first set of orders from the optional sets of orders is based on the delivery related parameters.

10. The method of claim 9, wherein the delivery related parameters include at least one of:
maximal allowed traveling time to the point of delivery;
maximal allowed traveling time between two or more points of delivery;
maximal allowed traveling time between all the delivery points in the set of orders;
a weather condition; and
a predefined maximal time for delivery of the order.

11. The method of claim 1, further comprising:
determining time indicators to each courier from a plurality of available couriers, and
wherein determining the arrival time at the preparation facility, of each courier is based on the time indicators.

12. The method of claim 11, wherein the time indicators include at least two of:
the courier is at the facility;
the expected arrival of the courier at the preparation facility is less than a first predetermined duration of time;
the expected arrival of the courier at the preparation facilities less than a second predetermined duration of time, the second predetermined duration of time is larger than the first predetermined duration of time;
the expected arrival time of the courier at the preparation facility is greater than the second predetermined duration of time;
the expected arrival of the courier at the preparation facility is less than a calculated preparation time of one or more stages in the preparation of a good included in a set of orders.

13. The method of claim 12, further comprising:
determining if a courier is an available courier if the courier is at the facility or the expected arrival time of the courier to the facility is less than the second predetermined duration of time.

14. The method of claim 1, wherein the expected arrival time for each courier is calculated based on information received from a transmitter associated with the courier.

15. The method of claim 1, further comprising:
receiving an indication of an unexpected event, wherein the unexpected event effects at least one of: the preparation of at least one order from the plurality of orders and the delivery of at least one order from the plurality of orders;
determining an effect of the unexpected event on one or more parameters from:
the estimated traveling time from the preparation facility to at the least two points of delivery;
the traveling time between the at least two points of delivery;
the an expected arrival time;
a preparation parameter;
a delivery parameter; and
a facility parameter;
selecting an operation mode based on the determined effect;
updating the one or more parameters' values based on the selected operation mode and determined effect; and
selecting and assigning the first set to the first courier based on the updated one or more parameters' values to minimize an average delivery time of the first set of orders.

16. The method of claim 1, further comprising:
receiving a preparation facility parameter; and
wherein selecting the first set of orders, selecting the first courier and assigning the first set to the first courier is based on the preparation facility parameter.

17. The method of claim 11, wherein the facility parameter includes at least one of:
a number of workers available for preparing the first set of orders;
a number of available couriers; and
a number of preparation units available for preparing the first set of orders.

18. A system for managing preparation and delivery of goods, comprising:
an order receiving unit;
a communication unit in communication with a plurality of mobile devices each associated with a courier;
a processor for executing instructions;
a flow instruction timing unit comprising an output device to provide preparation timing indications for each good included in the order received in orders receiving unit; and
a memory stored thereon instructions to be executed by the processor,
wherein the instructions comprise:
receiving a plurality of orders via the orders receiving unit, each order comprising one or more requested goods and a point of delivery, wherein each of the requested goods requires at least one preparation stage;
calculating estimated traveling time from a preparation facility to at least two points of delivery of at least two of the plurality of orders;
estimating at least a traveling time between the at least two points of delivery received for the at least two of the plurality of orders;
determining optional sets of orders from the plurality of orders, wherein each of said set of orders comprises at least one order;
selecting a first set of orders from the optional sets of orders based at least on the calculated traveling time and the estimated traveling time between the points of delivery;
determining arrival time at the preparation facility, of each courier from a plurality of available couriers, the arrival time is determined based on information received from the plurality of mobile devices;
selecting a first courier from the plurality of available couriers based on the determined arrival time at the preparation facility;
assigning the first set to the first courier,
wherein selecting of the first set of orders, selecting the first courier and assigning the first set to the first courier minimize an average time for a delivery of the first set of orders; and
determining a timing for the at least one preparation stage of the requested good in the first set of orders according to the selection of the first set and the first courier.

19. The system of claim 18, further comprising:
a presentation unit, and
wherein the instructions further include:
presenting the determined timing using the presentation unit.

20. The system of claim 18;
wherein each of the mobile devices includes a localization system.

21. The system of claim 20, wherein each of the mobile devices includes a display, and wherein the instructions further includes:
displaying to the first courier data related to the first set of orders.
